(19) United States
(12) Patent Application Publication
(10) Pub. No.: US 2019/0323924 A1
(43) Pub. Date: Oct. 24, 2019

(54) TESTING DEVICE FOR VEHICLES

(71) Applicant: KAI-EE INC., New Taipei City (TW)

(72) Inventor: Chia-Chun HONG, New Taipei City (TW)

(21) Appl. No.: 15/958,962

(22) Filed: Apr. 20, 2018

(51) Int. Cl. G01M 15/09; G01L 19/00

(52) U.S. Cl. CPC G01M 15/09; G01L 19/0015

(57) ABSTRACT

A testing device for vehicles includes a pressure gauge, a multidirectional joint, a quick combination unit, and a deflation valve unit. The pressure gauge has a main body provided with a connecting portion. The multidirectional joint has at least three openings communicating with each other. The multidirectional joint is directly disposed on the connecting portion of the main body, enabling gas to flow into the pressure gauge through one of the openings. The quick combination unit and the deflation valve unit are disposed on the other two openings respectively. Because the multidirectional joint is directly disposed on the main body of the pressure gauge, the main body uses the connecting portion thereof to be combined with the multidirectional joint, so that the component cost and the manufacturing time are effectively reduced, the manufacturing cost is lowered, the production yield rate and the product quality are highly improved.

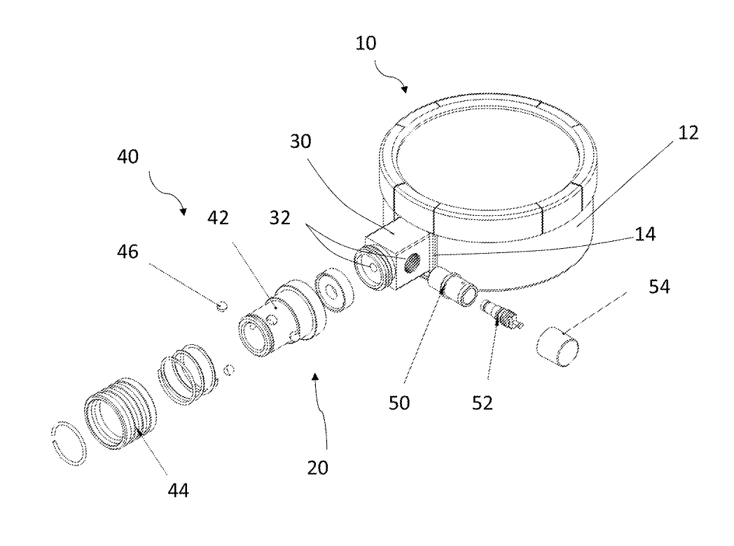

### BACKGROUND OF THE INVENTION

### 1. Field of the Invention

The present invention relates to testing devices and more particularly, to a testing device for vehicles.

### 2. Description of the Related Art

For testing the performance of the engine of the internal-combustion-engine-type vehicle by confirming whether the internal pressure of the engine and the fuel supply device meets the standard specification data, a testing device is usually used to test the practical performance of the aforesaid members during the maintenance process.

The conventional testing device includes a pressure gauge, a gas communication pipe, and a gas control member. The pressure gauge is combined with the gas communication pipe and the gas control member by various joints. However, the whole aforesaid testing device has relatively more connecting members, resulting in relatively higher cost, relatively longer manufacturing time, and uneasily controlled and improved quality yield rate.

### SUMMARY OF THE INVENTION

Therefore, it is a primary objective of the present invention to provide a testing device for vehicles, which is reduced in component cost and manufacturing time, lowered in manufacturing cost, and highly improved in production yield rate and product quality.

To attain the above objective, the present invention provides a testing device for vehicles, which includes a pressure gauge, a multidirectional joint, a quick combination unit, and a deflation valve unit. The pressure gauge has a main body provided with a connecting portion. The multidirectional joint has three openings communicating with each other. The multidirectional joint is directly disposed on the connecting portion of the main body for enabling gas to flow into the pressure gauge through one of the openings. The quick combination unit and the deflation valve unit are disposed on the other two openings respectively. Because the multidirectional joint is directly disposed on the main body of the pressure gauge and the main body uses the connecting portion thereof to be combined with the multidirectional joint, the component cost and the manufacturing time of the testing device are effectively reduced, the manufacturing cost of the testing device is lowered, and the production yield rate and the product quality of the testing device are highly improved.

In a preferred manner, the connecting portion is a through hole, and the multidirectional joint is directly embedded in the connecting portion in a tight fit manner.

In a preferred manner, the connecting portion is directly combined with the multidirectional joint by welding or gluing.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The sole FIGURE is an exploded perspective view of a preferred embodiment of the present invention.

### DETAILED DESCRIPTION OF THE INVENTION

First of all, it is to be mentioned that the present invention is widely applicable in various testing devices for vehicles or carriers. Those skilled in this field should understand that the illustrative phraseology in the detailed description of the invention belongs to a generic description of unlimited applicatory fields. For example, the meaning of the word “connecting” or “combination (combined)” includes, but unlimited to, the combination and connection using screws, rivets, tightly hooking members and so on. The directional phraseology is used for example only. The meaning of the quantitative word “a (one)” for each element includes one and more than one or a plurality of elements.

Referring to the sole FIGURE, the present invention provides a testing device for vehicles, which includes a pressure gauge 10, and a pipe communication module 20. The pressure gauge 10 has a main body 12 which is provided on the outer peripheral surface thereof with a connecting portion 14. The configuration type of the connecting portion 14 can be set correspondingly according to the usage or manufacturing manner. For example, the connecting portion 14 in this preferred embodiment is a through hole, which may be changed into other adaptable design and modification for being combined with the pipe communication module 20.

The pipe communication module 20 includes a multidirectional joint 30. The multidirectional joint 30 in this preferred embodiment has at least three openings 32 communicating with each other. The multidirectional joint 30 is directly disposed on the connecting portion 14 of the pressure gauge 10. In this preferred embodiment, the multidirectional joint 30 can be directly embedded in the connecting portion 14 in a tight fit manner. Alternatively, the multidirectional joint 30 can be directly combined with the connecting portion 14 of the pressure gauge 10 by welding, gluing or other similar manners. One of the openings 32 correspondingly communicates with the pressure gauge 10, enabling gas to flow into the pressure gauge 10 through the opening 32. A quick combination unit 40 and a deflation valve unit 50 are disposed on the other two openings 32 of the multidirectional joint 30 respectively. The quick combination unit 40 includes a base 42 and a sliding sleeve 44 capable of sliding on the base 42 back and forth, for a testing pipe (not shown) to be detachably disposed on the quick combination unit 40. When the sliding sleeve 44 moves relative to the base 42, it constricts or releases the positioning balls 46 disposed on the base 42 so as to cause the testing pipe to be combined with or separated from the quick combination unit 40. The deflation valve unit 50 includes a movable gas plug 52 and an operating portion 54. The user can press the operating portion 54 to control the moving condition of the gas plug 52 so as to switch the gas flow of the whole testing device between close and deflated modes.

Through the aforesaid technical features, the multidirectional joint 30 is directly disposed on the main body 12 of the pressure gauge 10; in the manufacturing process of the testing device, the main body 12 uses the connecting portion 14 thereof to be combined with the multidirectional joint 30, and the assembly of the whole testing device can be accomplished without any additional element. Therefore, the component cost and the manufacturing time of the testing device are effectively reduced, the manufacturing cost of the testing device is lowered, and the production yield rate and the product quality of the testing device are highly improved. Besides, because the quick combination unit 40 and the deflation valve unit 50 are directly disposed on the multidirectional joint 30, all the primary functions of the present invention are integrated compactly, the whole space arrangement is simplified, the volume is decreased, and the operational convenience and utilization are improved.

What is claimed is:

1. A testing device for vehicles, the testing device comprising:
a pressure gauge having a main body provided with a connecting portion;
a multidirectional joint having three openings communicating with each other, the multidirectional joint being directly disposed on the connecting portion of the main body for enabling gas to flow into the pressure gauge through one of the openings;
a quick combination unit and a deflation valve unit disposed on the other two openings respectively.

2. The testing device as claimed in claim 1, wherein the connecting portion is a through hole; the multidirectional joint is directly embedded in the connecting portion in a tight fit manner.

3. The testing device as claimed in claim 1, wherein the connecting portion is directly combined with the multidirectional joint by welding or gluing.

4. The testing device as claimed in claim 1, wherein the quick combination unit comprises a base and a sliding sleeve capable of sliding on the base back and forth; movement of the sliding sleeve relative to the base is capable of constricting or releasing a positioning ball disposed on the base.

5. The testing device as claimed in claim 1, wherein the deflation valve unit comprises a movable gas plug and an operating portion capable of being pressed to control moving condition of the gas plug so as to switch gas flow of the whole testing device between close and deflated modes.
